(19) United States
(12) Patent Application Publication
(10) Pub. No.: US 2025/0303821 A1
(43) Pub. Date: Oct. 2, 2025

(54) AIR CONDITIONING SYSTEM

(71) Applicant: NGK INSULATORS, LTD., Nagoya-City (JP)

(72) Inventors: Koji KUZUTANI, Konan-Shi (JP); Takahiko NAKATANI, Kani-Shi (JP); Yuta UNAMI, Nagoya-Shi (JP); Takuya ISHIHARA, Tsushima-Shi (JP)

(73) Assignee: NGK INSULATORS, LTD., Nagoya-City (JP)

(21) Appl. No.: 19/071,970

(22) Filed: Mar. 6, 2025

(30) Foreign Application Priority Data
Apr. 2, 2024 (JP) 2024-059790

(51) Int. Cl. B60H 1/00

(52) U.S. Cl. CPC B60H 1/00899; B60H 1/00392

(57) ABSTRACT

An air conditioning system includes a heat pump cycle having a refrigerant pipe capable of circulating a refrigerant therethrough, and a compressor capable of compressing the refrigerant. A heating portion capable of circulating the refrigerant therethrough and capable of heating the refrigerant by electromagnetic induction is connected in the middle of the refrigerant pipe.

### CROSS REFERENCE TO RELATED APPLICATIONS

The present invention claims the benefit of priority to Japanese Patent Application No 2024-059790 filed on Apr. 2, 2024 with the Japanese Patent Office, the entire contents of which are incorporated herein by reference in its entirety.

### FIELD OF THE INVENTION

The present invention relates to an air conditioning system.

### BACKGROUND OF THE INVENTION

There is known an air conditioning system capable of cooling and heating using a heat pump cycle. The air conditioning system has advantages such as power saving, and is therefore also used in vehicles such as battery electric vehicles (BEVs). The heat pump cycle has a structure in which components such as a compressor, a condenser, an evaporator, and an expansion valve(s) are connected in a ring shape by a refrigerant pipe, and can perform cooling and heating by utilizing the heat of vaporization and condensation of the refrigerant.

However, the air conditioning system that uses the heat pump cycle have a problem of decreasing initial heating performance in cold weather (start of heating is slower) because it converts outside air to heat. Specifically, in cold weather, the temperature of the refrigerant flowing through the heat pump cycle is lower, so that the temperature and pressure of the refrigerant do not increase easily upon the start of heating. It results in slow start of heating and takes a long period of time to feed warm air.

To solve this problem, Patent Literature 1 proposes an air conditioning system (vehicle air conditioner) that controls an amount of air sent to a vehicle interior heat exchanger, which acts as a radiator, to decrease upon the start of heating. Patent Literature 2 also proposes an air conditioning system (vehicle air conditioner) that increases an amount of heat of a refrigerant by a refrigerant heater to speed up the start of heating.

However, the air conditioning system of Patent Literature 1 reduces the amount of air sent to the radiator (vehicle interior heat exchanger) upon the start of heating, thereby reducing the amount of heat exchanged between the refrigerant discharged from the compressor and the outside air as the refrigerant flows through the radiator to facilitate the increase in the temperature of the refrigerant, but the refrigerant is not heated, and therefore it cannot be said that the initial heating performance is sufficient.

Also, the air conditioning system of Patent Literature 2 heats the refrigerant with a refrigerant heater composed of a sheathed heater (electric heater), which results in high power consumption. For this reason, for example, if the air conditioning system is used in an electric vehicle, there is a problem that the driving range is significantly reduced due to energy loss.

The present invention was made to solve the problems as described above. An object of the present invention is to provide an air conditioning system capable of improving initial heating performance while suppressing power consumption.

### PRIOR ART

### Patent Literatures

### [Patent Literature 1] Japanese Patent Application Publication No. 2014-24371 A

### [Patent Literature 2] Japanese Patent Application Publication No. 2014-131914 A

### SUMMARY OF THE INVENTION

As a result of intensive studies for air conditioning systems using heat pump cycles, the present inventors have found that the above problems can be solved by connecting a predetermined heating portion in the middle of a refrigerant pipe through which the refrigerant flows and heating the refrigerant, and they have completed the present invention. That is, the present invention is illustrated as follows:

An air conditioning system comprising a heat pump cycle having: a refrigerant pipe capable of circulating a refrigerant therethrough; and a compressor capable of compressing the refrigerant,
wherein a heating portion capable of circulating the refrigerant therethrough and capable of heating the refrigerant by electromagnetic induction is connected in the middle of the refrigerant pipe.

The air conditioning system according to [1], wherein the heating portion comprises: a honeycomb structure having an outer peripheral wall and partition walls disposed on an inner side of the outer peripheral wall, the partition walls defining a plurality of cells, each of the cells extending from a first end face to a second end face, at least one of the cells being provided with a magnetic material; and a coil wiring spirally wound around an outer periphery of the honeycomb structure.

The air conditioning system according to [1], wherein the heating portion comprises: a honeycomb structure having an outer peripheral wall and partition walls disposed on an inner side of the outer peripheral wall, the partition walls defining a plurality of cells, each of the cells extending from a first end face to a second end face, at least the partition walls comprising a magnetic material; and a coil wiring spirally wound around an outer periphery of the honeycomb structure.

The air conditioning system according to [2] or [3], wherein the heating portion further comprises a metallic outer cylindrical member for housing the honeycomb structure and the coil wiring.

The air conditioning system according to [4], wherein the heating portion further comprises an inner cylindrical member between the honeycomb structure and the coil wiring.

The air conditioning system according to [5], wherein the heating portion further comprises a holding member between the honeycomb structure and the inner cylindrical member.

The air conditioning system according to any one of [1] to [6], wherein the heating portion is connected in the middle of the refrigerant pipe on an upstream side, a downstream side, or both of the upstream and the downstream sides of the compressor, based on a flow direction of the refrigerant.

The air conditioning system according to any one of [2] to [7], wherein the magnetic material comprises at least one element selected from the group of Fe, Cr, Ni, Mn, Zn, Co, Cu and Si.

The air conditioning system according to any one of [1] to [8], wherein the air conditioning system further comprises a control unit for controlling the heat pump cycle and the heating portion, and
wherein the control unit comprises controlling so as to heat the refrigerant in the heating portion by electromagnetic induction upon start of a heating operation mode of the heat pump cycle.

The air conditioning system according to [9], wherein the heat pump cycle further comprises a condenser for exchanging heat between air flowing through an air conditioning duct and the refrigerant, and
wherein the heating operation mode comprises compressing the refrigerant with the compressor and introducing the refrigerant discharged from the compressor into the condenser to heat the air.

The air conditioning system according to [10], wherein the heat pump cycle further comprises:
an evaporator for exchanging heat between the air flowing through the air conditioning duct and the refrigerant; and
an outdoor heat exchanger for exchanging heat between outside air and the refrigerant.

The air conditioning system according to [11], wherein the heating portion is connected in the middle of the refrigerant pipe at a position between the compressor and the condenser, or at a position between the compressor and the evaporator or the outdoor heat exchanger, or the heat portions are connected in the middle of the refrigerant pipe at both positions.

The air conditioning system according to any one of [1] to [12], wherein the air conditioning system is for a vehicle.

### BRIEF DESCRIPTION OF THE DRAWINGS

FIG. 1A is a schematic configuration view of a vehicle air conditioning system according to an embodiment of the present invention, which shows an operating state during a heating operation mode;

FIG. 1B is a schematic configuration view of a vehicle air conditioning system according to an embodiment of the present invention, which shows an operating state during a cooling operation mode;

FIG. 1C is a schematic configuration view of a vehicle air conditioning system according to an embodiment of the present invention, which shows an operating state during another cooling operation mode;

FIG. 2A is a schematic cross-sectional sectional view of a heating portion used in an air conditioning system according to an embodiment of the present invention, which is orthogonal to an extending direction of cells;

FIG. 2B is a schematic cross-sectional view of the heating portion taken along the line a-a′ in FIG. 2A;

FIG. 3A is a schematic cross-sectional view of another heating portion used in an air conditioning system according to an embodiment of the present invention, which is orthogonal to an extending direction of cells; and

FIG. 3B is a schematic cross-sectional view of the heating portion in FIG. 3A taken along the line b-b′.

### DETAILED DESCRIPTION OF THE INVENTION

An air conditioning system according to the present invention includes a heat pump cycle having a refrigerant pipe capable of circulating a refrigerant therethrough, and a compressor capable of compressing the refrigerant, wherein a heating portion capable of circulating the refrigerant therethrough and capable of heating the refrigerant by electromagnetic induction is connected in the middle of the refrigerant pipe. With such a structure, the air conditioning system according to the present invention can rapidly heat the refrigerant in cold weather, so that initial heating performance can be improved. Also, the air conditioning system according to the present invention can reduce power consumption as compared to air conditioning systems that use conventional sheathed heaters (electric heaters) to heat the refrigerant, so that it leads to energy savings and, particularly when applied to electric vehicles, the driving range can be extended.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

The air conditioning system according to the present invention can be used in various facilities and products that require air conditioning. For example, the air conditioning system according to the present invention can be used in air conditioners used in offices and homes, home appliances such as refrigerators and washer-dryers, and various vehicles such as automobiles. Among them, the air conditioning system according to the present invention is suitable for use in various vehicles such as automobiles. The vehicles include, but not limited to, automobiles and electric trains. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The vehicle air conditioning system according to an embodiment of the present invention can be particularly suitably used for a vehicle having no internal combustion engine such as electric vehicles and electric trains.

It should be noted that in the following descriptions, air conditioning systems for use in vehicles will be described as an example, but, needless to say, the present invention can also be used in the various facilities and products as described above.

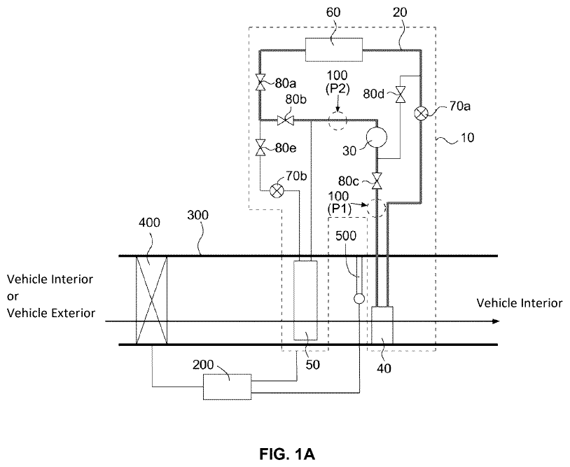

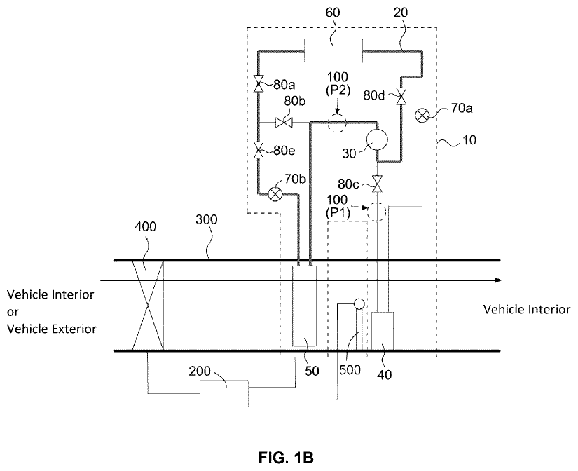

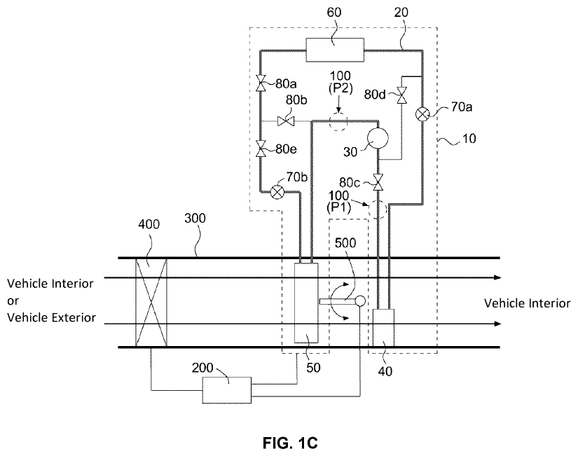

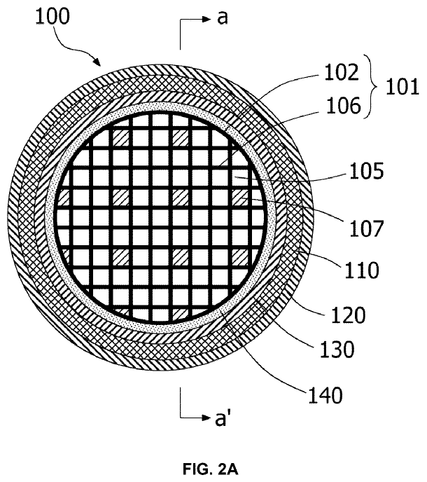

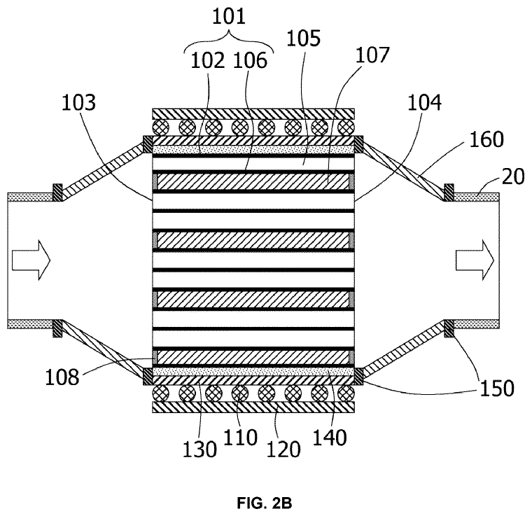

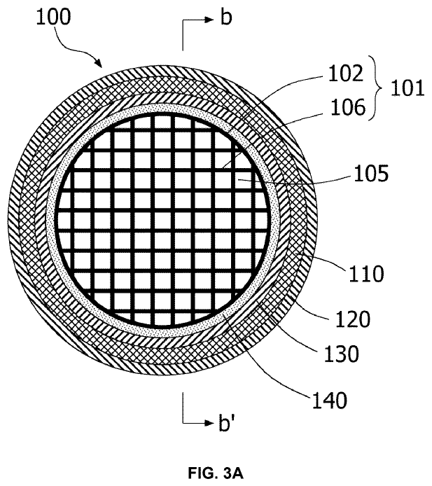

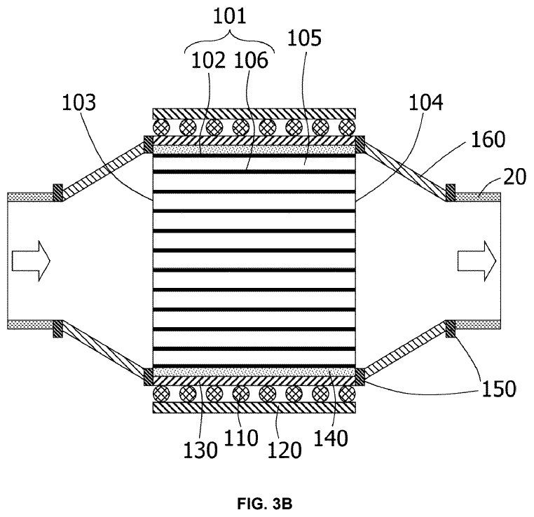

Each of FIGS. 1A to 1C is a schematic configuration view of an air conditioning system according to an embodiment of the present invention, which shows an operation state during each operation mode. In particular, FIG. 1A is the heating operation mode, and FIGS. 1B and 1C are the cooling operation mode. FIG. 2A is a schematic cross-section view of a heating portion used in an air conditioning system according to an embodiment of the present invention, which is orthogonal to a flow direction of the refrigerant. FIG. 2B is a schematic cross-sectional view of the heating portion of FIG. 2a taken along the line a-a′. FIG. 3A is a schematic cross-sectional view of another heating portion used in an air conditioning system according to an embodiment of the present invention, which is orthogonal to a flowing direction of the refrigerant; and FIG. 3B is a schematic cross-sectional view of the heating portion taken along the line b-b′ in FIG. 3A.

The air conditioning system according to an embodiment of the present invention includes: a heat pump cycle 10; and a heating portion 100. Also, the air conditioning system can further include: a control unit 200; an air conditioning duct 300; a ventilation fan 400; and an air mix door 500.

Hereinafter, each of these components will be described in detail.

### 1. Heat Pump Cycle 10

The heat pump cycle 10 has a refrigerant pipe 20 and a compressor 30. The structure of the heat pump cycle 10 is not particularly limited and a known structure can be adopted, as long as the heat pump cycle 10 has those components. For example, the heat pump cycle 10 can further have a condenser 40, an evaporator 50, an outdoor heat exchanger 60, expansion valves 70a, 70b, and shut-off valves 80a to 80e. The condenser 40 and the evaporator 50 are provided in the air conditioning duct 300.

The refrigerant pipe 20 is a component through which the refrigerant can be circulated, and connects various components such as the compressor 30 and condenser 40.

The compressor 30 is a component that can compress the refrigerant. Specifically, the compressor 30 is driven by the control unit 200, and compresses the refrigerant, thereby discharging a high-temperature, high-pressure refrigerant to the condenser 40.

In addition, a known device such as a gas-liquid separator may be provided on an upstream side of the compressor 30.

The condenser 40 is a component that exchanges heat between the air flowing through the air conditioning duct 300 and the refrigerant. Specifically, when the heating operation mode is performed, the condenser 40 is capable of dissipating heat using the high-temperature, high-pressure refrigerant flowing inside, and heats the air around the condenser 40 flowing through the air conditioning duct 300.

The evaporator 50 is also a component that exchanges heat between the air flowing through the air conditioning duct 300 and the refrigerant. Specifically, when the cooling operation mode is performed, the evaporator 50 is capable of absorbing heat using the low-temperature, low-pressure refrigerant flowing inside, and cools the air around the evaporator 50 flowing through the air conditioning duct 300.

The outdoor heat exchanger 60 is a component that exchanges heat between the outside air and the refrigerant. The outdoor heat exchanger 60 is capable of absorbing the heat from the outside air using a low-temperature, low-pressure refrigerant flowing inside, and vaporizes the refrigerant by absorbing the heat from the outside air, mainly when executing the heating operation mode. Moreover, the outdoor heat exchanger 60 can release the heat to the outside air by the high-temperature, high-pressure refrigerant flowing inside, and cools the refrigerant by releasing the heat to the outside air, mainly when executing the cooling operation mode.

The expansion valves 70a, 70b are throttle valves whose opening degrees can be adjusted by the control unit 200. In particular, when the heating operation mode is executed, the expansion valve 70a reduces the pressure of the refrigerant discharged from the condenser 40 to expand it, and then discharges the low-temperature, low-pressure refrigerant to the outdoor heat exchanger 60. Furthermore, when the cooling operation mode is executed, the expansion valve 70b reduces the pressure of the refrigerant from the outdoor heat exchanger 60 to expand it, and then discharge the low-temperature, low-pressure refrigerant to the evaporator 50.

The shutoff valves 80a to 80e are provided to control the flow path of the refrigerant. The opening and closing of the shutoff valves 80a to 80e are controlled by the control unit 200.

### 2. Heating Portion 100

The heating portion 100 is capable of circulating the refrigerant therethrough and capable of heating the refrigerant by electromagnetic induction, and is connected in the middle of the refrigerant pipe 20. Although the connecting position of the heating portion 100 is not particularly limited, the heating portion 100 can be connected in the middle of the refrigerant pipe 20 on an upstream side, a downstream side, or both of the upstream and the downstream sides of the compressor 30, based on the flow direction of the refrigerant. Specifically, in the air conditioning system shown in FIGS. 1A to 1C, the heating portion 100 can be connected in the middle of the refrigerant pipe 20 between the compressor 30 and the condenser 40 (e.g., at a position P1), between the compressor 30 and the evaporator 50 or the outdoor heat exchanger 60 (e.g., at a position P2), or at both of the positions (e.g., at positions P1 and P2). By arranging the heating portion(s) 100 at such a position(s), the refrigerant can be rapidly heated in cold weather, so that the initial heating performance can be improved.

The heating portion 100 is not limited as long as the refrigerant can be circulated and the refrigerant can be heated by electromagnetic induction.

For example, as shown in FIGS. 2A and 2B, the heating portion 100 includes: a honeycomb structure 101 including an outer peripheral wall 102 and partition walls 106 that are disposed on an inner side of the outer peripheral wall 102 and define a plurality of cells 105 each extending from a first end face 103 to a second end face 104, at least one of the cells 105 being provided with a magnetic material 107; and a coil wiring 110 spirally wound around the outer periphery of the honeycomb structure 101. In the heating portion 100 having such a structure, a periodically changing magnetic field is generated around the coil wiring 110 when an AC current supplied from an AC power source (not shown) is applied to the coil wiring 110. In this case, eddy current flows through the magnetic material 107 located in at least one of the 105 cells, and Joule heat is generated accordingly, thereby heating the honeycomb structure 101. Also, by using such a heating portion 100, the heating portion 100 is brought into direct contact with the refrigerant, so that the heating efficiency is increased and the power consumption can be reduced, as compared to a conventional sheathed heater (electric heater).

Also, as shown in FIGS. 3A and 3B, the heating portion 100 includes: a honeycomb structure 101 including an outer peripheral wall 102 and partition walls 106 that are disposed on an inner side of the outer peripheral wall 102 and define a plurality of cells 105 each extending from a first end face 103 to a second end face 104, at least the partition walls 106 including a magnetic material 107; and a coil wiring 110 spirally wound around the outer periphery of the honeycomb structure 101. It should be noted that in FIGS. 3A and 3B, the magnetic material 107 contained in the partition walls 106 is not shown. That is, instead of placing the magnetic material 107 in at least one cell 105, the heating portion 100 shown in FIGS. 3A and 3B uses a material containing the magnetic material 107 to form at least the partition walls 106. Even in the heating portion 100 having such a structure, the flowing of the AC current to the coil wiring 110 allows the eddy current to flow in the magnetic material 107 contained at least in the partition walls 106, and Joule heat is generated accordingly, thereby heating the honeycomb structure 101. Also, by using such a heating portion 100, the heating portion 100 is brought into direct contact with the refrigerant, so that the heating efficiency is increased and the power consumption can be reduced, as compared to a conventional sheathed heater (electric heater). Furthermore, this heating portion 100 does not provide the magnetic element 107 in the cells 105, which will increase the number of cells 105 that serve as flow paths for the refrigerant, thereby reducing an increase in pressure loss.

The shape of the honeycomb structure 101 is not particularly limited. For example, an outer shape of a cross section of the honeycomb structure 101 orthogonal to the extending direction of the cells 105 of the honeycomb structure 101 can be polygonal such as quadrangular (rectangular, square), pentagonal, hexagonal, heptagonal, and octagonal, circular, oval (egg-shaped, elliptical, elliptic, rounded rectangular, etc.), or the like. The end faces (first end face 103 and second end face 104) have the same shape as the cross section. Also, when the cross section and the end faces are polygonal, the corners may be chamfered.

The shape of each cell 105 is not particularly limited, but it may be polygonal such as quadrangular, pentagonal, hexagonal, heptagonal, and octagonal, circular, or oval in the cross section of the honeycomb structure 101 orthogonal to the extending direction of the cells 105. These shapes may be formed alone or in combination of two or more. Moreover, among these shapes, the quadrangle or the hexagon is preferable.

The honeycomb structure 101 may be a honeycomb joined body having a plurality of honeycomb segments and joining layers that join outer peripheral side surfaces of the plurality of honeycomb segments together. The use of the honeycomb joined body can increase the total cross-sectional area of the cells 105, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain the same material as the outer peripheral wall 102 and the partition walls 106. In addition to the role of joining the honeycomb segments to each other, the joining material can also be used as an outer peripheral coating material after joining the honeycomb segments

The thickness of the outer peripheral wall 102 is not particularly limited, but it may preferably be 0.2 to 0.8. The thickness of the outer peripheral wall 102 of 0.2 mm or more allows the strength of the honeycomb structure 101 to be ensured. Furthermore, the thickness of the outer peripheral wall 102 of 0.8 mm or less allows weight reduction to be ensured.

As used herein, the thickness of the outer peripheral wall 102 refers to a length in the normal direction from a boundary between the outer peripheral wall 102 and the outermost cell 105 or partition wall 106 to the outer surface of the honeycomb structure 101 in a cross section orthogonal to the extending direction of the cells 105.

The thickness of the partition walls 106 is not particularly limited, but it may preferably be 0.01 to 0.3 mm, more preferably 0.02 to 0.2 mm, and even more preferably 0.03 to 0.1 mm. By controlling the thickness of the partition walls 106 within such a range, the strength of the honeycomb structure 101 can be ensured.

As used herein, the thickness of the partition walls 106 refers to a length of a line segment that crosses the partition wall 106 when the line segment connects the centers of gravity of adjacent cells 105 in a cross section orthogonal to the extending direction of the cells 105. The thickness of the partition walls 106 refers to an average thickness of all the partition walls 106.

The cell density is not particularly limited, but it may preferably be 30 to 100 cells/cm², more preferably 35 to 70 cells/cm², and further preferably 40 to 65 cells/cm². By controlling the cell density within such a range, the strength of the honeycomb structure 101 and the like can be ensured.

As used herein, the cell density refers a value obtained by dividing a number of cells by an area of one end face (first end face 103 or second end face 104) of the honeycomb structure 101 (the total area of the partition walls 106 and the cells 105 excluding the outer peripheral wall 102).

The cell pitch is not particularly limited, but it may preferably be 1.0 to 2.0 mm, more preferably 1.2 to 1.8 mm, and further preferably 1.3 to 1.6 mm. By controlling the cell pitch within such a range, the strength of the honeycomb structure 101 and the like can be ensured.

As used herein, the cell pitch refers to a value obtained by the following calculation. First, the area of one end face (first end face 103 or second end face 104) of the honeycomb structure 101 (the total area of the partition walls 106 and the cells 105 excluding the outer peripheral wall 102) is divided by the number of the cells to calculate an area per a cell. A square root of the area per a cell is then calculated, and this is determined to be the cell pitch.

The length in the extending direction of the cells 105 and the cross-sectional area orthogonal to the flow path direction of the honeycomb structure 101 may be adjusted according to the required size of the heating portion 100, and are not particularly limited. For example, when used in a compact heating portion 100 while ensuring a predetermined function, the honeycomb structure 101 can have a length of 2 to 20 mm in the extending direction of the cells 105 and a cross-sectional area of 10 cm² or more orthogonal to that direction. Although the upper limit of the cross-sectional area orthogonal to the extending direction of the cells 105 is not particularly limited, it is, for example, 300 cm².

The outer peripheral wall 102 and the partition walls 106 making up the honeycomb structure 101 shown in FIGS. 2A and 2B are made of a ceramic material. The ceramic materials include, but not limited to, silica (SiO₂), alumina (Al₂O₃), magnesia (MgO), zirconia (ZrO₂), titania (TiO₂), cordierite (2MgO·2SiO₂-5SiO₂), silicon carbide (SiC), aluminum titanate (Al₂O₃·TiO₂), silicon carbide (Si₃N₄), mullite (3Al₂O₃·2SiO₂), silicon-silicon carbide composite materials, silicon carbide- cordierite composite materials, and the like. These can be used alone or in combination of two or more.

The outer peripheral wall 102 and the partition walls 106 making up the honeycomb structure 101 shown in FIGS. 3A and 3B further include a magnetic material 107 in addition to the ceramic material.

The same ceramic materials can be used as those described above.

The magnetic material 107 is not limited as long as the eddy current flows through the magnetic material 107 when an alternating current is applied to the coil wiring 110, and Joule heat is generated accordingly. Examples of the magnetic material 107 preferably include at least one element selected from the group of Fe, Cr, Ni, Mn, Zn, Co, Cu and Si. In other words, the magnetic material 107 can be a metal made of these elements or an alloy thereof. Specific examples of the magnetic material 107 include: balance Co-20 mass % Fe; balance Co-25 mass % Ni-4 mass % Fe; balance Fe-15 to 35 mass % Co; balance Fe-17 mass % Co-2 mass % Cr-1 mass % Mo; balance Fe-49 mass % Co-2 mass % V; balance Fe-18 mass % Co-10 mass Cr-2 mass % Mo-1 mass % Al; balance Fe-27 mass % Co-1 mass % Nb; balance Fe-20 mass % Co-1 mass % Cr-2 mass % V; balance Fe-35 mass % Co-1 mass % Cr; balance Fe-17 mass % Cr; pure cobalt; pure iron; electromagnetic soft iron, balance Fe-0.5 mass % V 1-0.5 mass % Mn; balance Fe-3 mass % Si, and so on. These can be used alone or in combination of two or more.

The content of the magnetic material 107 is not limited as long as it does not impair properties such as strength of the honeycomb structure 101.

The method for producing the honeycomb structure 101 making up the heating portion 100 is not particularly limited, and it can be performed according to a known method. Hereinafter, a method for producing the typical honeycomb structure 101 will be illustratively described.

The method for producing the honeycomb structure 101 includes a forming step and a firing step.

In the forming step, a green body containing the ceramic material (or a green body further containing the magnetic material 107 if at least the partition walls 106 contain the magnetic material 107) is prepared. The green body can be obtained by adding a dispersion medium, a binder, a plasticizer and a dispersant to the ceramic material and kneading them.

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, thickness of each portion, cell density and the like can be used.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step is carried out at appropriate temperatures and for appropriate times depending on the type of ceramic material used.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

In the case of the honeycomb structure 101 shown in FIGS. 2A and 2B, the magnetic material 107 is placed in at least one cell 105. As the magnetic material 107, the above-mentioned materials can be used.

The magnetic material 107 may be filled into the cells 105, or the magnetic material 107 may be coated on the surfaces of the partition walls 106 and the outer wall 102 that make up the cells 105.

When the magnetic material 107 is filled into the cells 105, it is preferable to form plugged portions 108 for the cells 105 on the first end face 103 side and the second end face 104 side from the viewpoint of preventing the magnetic material 107 from falling out of the cells 105. The plugged portions 108 are not limited, but they are preferably formed of the ceramic material. As the ceramic material, the above-mentioned ceramic materials can be used. The plugged portions 108 can be formed by known methods.

When the magnetic 107 is coated on the surfaces of the partition walls 106 and the outer wall 102 that make up the cells 105, a slurry containing the magnetic material 107 can be applied to those surfaces and allowed to dry.

The coil wiring 110 spirals around the outer periphery of the honeycomb structure 101. In other words, the coil wiring 110 is spirally wound around the outer periphery of the honeycomb structure 101. There may be one or more coil wirings 110. The coil wiring 110 is connected to an AC power source, and the AC current supplied from the AC power source generates a magnetic field.

The heating portion 100 shown in FIGS. 2A, 2B, 3A, and 3B can further include a metallic outer cylindrical member 120 that houses the honeycomb structure 101 and the coil wiring 110. The outer cylindrical member 120 can be provided to suppress the effects on other components caused by the magnetic field generated when the AC current is applied to the coil wiring 110, i.e., to ensure a magnetic shielding effect.

The material that makes up the outer cylindrical member 120 is not limited as long as it has the magnetic shielding effect, but from the viewpoint of manufacturability, it is preferably a metal. Examples of the metal that can be used herein includes stainless steel, titanium alloys, copper alloys, aluminum alloys, and brass. Among them, the stainless steel is preferred because of its high durability and reliability and low cost.

The thickness of the outer cylindrical member 120 is not particularly limited, but it may preferably be 0.1 mm or more, preferably 0.3 mm or more, and even more preferably 0.5 mm or more. The thickness of the outer cylindrical member 120 of 0.1 mm or more allows the durability and reliability to be ensured. Moreover, the thickness of the outer cylindrical member 120 is preferably 10 mm or less, and more preferably 5 mm or less, and even more preferably 3 mm or less. The thickness of the outer cylindrical member 120 of 10 mm or less allows weight reduction to be achieved.

The heating portion 100 shown in FIGS. 2A, 2B, 3A and 3B can further include an inner cylindrical member 130 between the honeycomb structure 101 and the coil wiring 110. The inner cylindrical member 130 can ensure stable refrigerant flow while holding the honeycomb structure 101.

The material making up the inner cylindrical member 130 is not limited as long as the above functions can be obtained, but a metal is preferred from the viewpoint of manufacturability. The same metals as described above can be used, but the stainless steel is preferred because of its high durability and reliability and low cost. The thickness of the inner cylindrical member 130 is not limited, but it can be the same as the thickness of the outer cylindrical member 120.

The heating portion 100 shown in FIGS. 2a, 2b, 3a and 3b can further include a holding member 140 between the honeycomb structure 101 and the inner cylindrical member 130. The holding member 140 prevents the honeycomb structure 101 from being damaged by vibration and the like.

The material making up the holding member 140 is not limited as long as it has cushioning properties, and a compressible elastic material can be used. An example of the compressible elastic material includes a ceramic fiber mat. The ceramic fiber mat is particularly preferred because it is easily obtainable and processable, has sufficient heat resistance and cushioning properties, and is resistant to dust generation. Examples of the ceramic fiber mat include those mainly formed of ceramic fibers made of alumina, mullite, silicon carbide, silicon nitride, zirconia, titania, or composites of these materials.

The heating portion 100 shown in FIGS. 2A, 2B, 3A and 3B can further include a connecting member comprised of a flange 150 and a cone portion 160. Such a connecting member facilitates connection to the refrigerant pipe 20.

The material making up the flange 150 and the cone portion 160 is not limited as long as it can ensure the function as a connecting member, but from the viewpoint of manufacturability, a metal is preferred. The same metals as described above can be used, but the stainless steel is preferred because of its high durability and reliability and low cost.

### 3. Control Unit 200

The control unit 200 controls the heat pump cycle 10 and the heating portion 100 depending on the operation mode. The control unit 200 is electrically connected to the heat pump cycle 10 and the heating portion 100. Specifically, the control unit 200 is electrically connected to the shutoff valves 80a to 80e of the heat pump cycle 10, and can control the refrigerant flow path by opening and closing the shutoff valves 80a to 80e. Further, the control unit 200 is electrically connected to the expansion valves 70a, 70b of the heat pump cycle 10, and can control the degree of pressure reduction of the refrigerant by adjusting the opening degrees of the expansion valves 70a, 70b. Furthermore, the control unit 200 is connected to an AC power source for applying an AC current to the coil wiring 110 of the heating portion 100, and the AC current supplied to the coil wiring 110 can be controlled to adjust the heating state of the honeycomb structure 101. The AC power source is not particularly limited, and a battery or the like can be used.

The control unit 200 is electrically connected to a ventilation fan 400, an air mix door 500, and the like, in addition to the heat pump cycle 10 and the heating portion 100, and it can control these members.

The control unit 200 is generally an ECU (Engine (electronic) Control Unit), although not particularly limited thereto. The ECU includes a CPU for performing various calculation processes, a ROM for storing programs and data required for its control, a RAM for temporarily storing results of calculations performed by the CPU, and input/output ports for inputting and outputting signals to and from the outside.

### 4. Ventilation Fan 400

The ventilation fan 400 is provided to circulate the air through the air conditioning duct 300. The ventilation fan 400 is not particularly limited, and any known ventilation fan can be used.

The position of the ventilation fan 400 is not particularly limited, and it may be provided on an upstream side of the condenser 40 or the evaporator 50. However, the ventilation fan 400 may be provided on a downstream side of the condenser 40 or the evaporator 50.

### 5. Air mix Door 500

The air mix door 500 is configured to rotate in the air conditioning duct 300 between a heating position that opens a heating path toward the condenser 40 and a cooling position that opens a cooling path that bypasses the condenser 40. Furthermore, by rotating the air mix door 500 between the heating position and the cooling position, it can adjust a ratio of the air passing through the condenser 40 to the air bypassing the condenser 40, thereby adjusting the temperature of the air flowing into the vehicle interior.

In the air conditioning system according to the embodiment of the present invention, the operation mode of the heat pump cycle 10 can include a heating operation mode and a cooling operation mode. The operation mode of the heat pump cycle 10 can be selected depending on switch operations by the driver, temperature changes detected by various detection units, and the like.

### (A) Heating Operation Mode

As shown in FIG. 1A, the heating operation mode opens the shutoff valves 80a to 80c and closes the shutoff valves 80d and 80e, thereby forming a flow path such that the refrigerant sequentially flows through the compressor 30, the condenser 40, the expansion valve 70a, and the outdoor heat exchanger 60. It should be noted that, in FIG. 1A, the flow path through which the refrigerant flows in this heating operation mode is shown by a thicker line.

This heating operation mode includes compressing the refrigerant with compressor 30 and introducing the refrigerant discharged from compressor 30 into condenser 40 to heat the air. That is, the refrigerant compressed by the compressor 30 enters the condenser 40 as a high-temperature, high-pressure refrigerant, exchanges heat with the air flowing in the air conditioning duct 300, and releases the heat (heats the air). The refrigerant leaving the condenser 40 is pressure-reduced and expanded by the expansion valve 70a to form a low-temperature, low-pressure refrigerant, and then exchanges the heat with the outside air in the outdoor heat exchanger 60 to absorb the heat, and returns to the compressor 30.

When this heating operation mode is performed, the air flowing through the air conditioning duct 300 is heated by the condenser 40, and the heated air flows into the vehicle interior. The temperature of the air flowing into the vehicle interior can be adjusted by controlling the opening degree of the air mix door 500.

Further, when the heating operation mode is started, the control unit 200 includes controlling so that the refrigerant is heated by electromagnetic induction in the heating portion 100. Such controlling allows the refrigerant to be rapidly heated even if the temperature of the refrigerant in the heat pump cycle 10 is low in cold weather, so that the initial heating performance can be improved.

### (B) First Cooling Operation Mode

As shown in FIG. 1B, the first cooling operation mode opens the shutoff valves 80a, 80d, 80e and closes the shutoff valves 80b, 80c, thereby forming a flow path such that the refrigerant sequentially flows through the compressor 30, the outdoor heat exchanger 60, the expansion valve 70b and the evaporator 50. It should be noted that, in FIG. 1B, the flow path through which the refrigerant flows in this cooling operation mode is shown by a thicker line.

This cooling operation mode includes introducing the refrigerant pressure-reduced and expanded by the expansion valve 70b into the evaporator 50 to cool the air. That is, the refrigerant compressed by the compressor 30 to a high temperature and a high pressure is cooled by exchanging heat with the outside air and releasing the heat in the outdoor heat exchanger 60. The refrigerant leaving the outdoor heat exchanger 60 is pressure-reduced and expanded by the expansion valve 70b to form a low-temperature, low-pressure refrigerant, which enters the evaporator 50, and exchanges the heat with the air flowing through the air conditioning duct 300 to absorb the heat (cool the air). The refrigerant leaving the evaporator 50 returns to the compressor 30.

When the cooling operation mode is performed, the air flowing through the air conditioning duct 300 is cooled by the evaporator 50, and the cooled air flows into the vehicle interior. The cooling operation mode is particularly useful when it is desired to rapidly cool the vehicle interior (strong cooling operation mode).

### (C) Second Cooling Operation Mode

As shown in FIG. 1C, the second cooling operation mode opens the shutoff valves 80a, 80c, 80e and closes the shutoff valves 80b, 80d, thereby forming a flow path such that the refrigerant sequentially flows through the compressor 30, the condenser 40, the expansion valve 70a, the outdoor heat exchanger 60, the expansion valve 70b, and the evaporator 50. It should be noted that, in FIG. 1C, the flow path through which the refrigerant flows in this cooling operation mode is shown by a thicker line.

In the flow path for the refrigerant in the cooling operation mode, the condenser 40 and the expansion valve 70a are further disposed on the downstream side of the compressor 30. In the cooling operation mode, the cooling of the air by the evaporator 50 and the heating of the air by the condenser 40 can be adjusted by controlling the opening degree of the air mix door 500, so that the temperature of the air can be controlled to the optimum temperature.

### DESCRIPTION OF REFERENCE NUMERALS

10 heat pump cycle
20 refrigerant pipe
30 compressor
40 condenser
50 evaporator
60 outdoor heat exchanger
70a, 70b expansion valve
80a, 80b, 80c, 80d, 80e shut-off valve
100 heating portion
101 honeycomb structure
102 outer peripheral wall
103 first end face
104 second end face
105 cell
106 partition wall
107 magnetic material
108 plugged portion
110 coil wiring
120 outer cylindrical member
130 inner cylindrical member
140 holding member
150 flange
160 cone portion
200 control unit
300 air conditioning duct
400 ventilation fan
500 air mix door

1. An air conditioning system comprising a heat pump cycle having a refrigerant pipe capable of circulating a refrigerant therethrough, and a compressor capable of compressing the refrigerant,
wherein a heating portion capable of circulating the refrigerant therethrough and capable of heating the refrigerant by electromagnetic induction is connected in the middle of the refrigerant pipe.

2. The air conditioning system according to claim 1, wherein the heating portion comprises: a honeycomb structure having an outer peripheral wall and partition walls disposed on an inner side of the outer peripheral wall, the partition walls defining a plurality of cells, each of the cells extending from a first end face to a second end face, at least one of the cells being provided with a magnetic material; and a coil wiring spirally wound around an outer periphery of the honeycomb structure.

3. The air conditioning system according to claim 1, wherein the heating portion comprises: a honeycomb structure having an outer peripheral wall and partition walls disposed on an inner side of the outer peripheral wall, the partition walls defining a plurality of cells, each of the cells extending from a first end face to a second end face, at least the partition walls comprising a magnetic material; and a coil wiring spirally wound around an outer periphery of the honeycomb structure.

4. The air conditioning system according to claim 2, wherein the heating portion further comprises a metallic outer cylindrical member for housing the honeycomb structure and the coil wiring.

5. The air conditioning system according to claim 4, wherein the heating portion further comprises an inner cylindrical member between the honeycomb structure and the coil wiring.

6. The air conditioning system according to claim 5, wherein the heating portion further comprises a holding member between the honeycomb structure and the inner cylindrical member.

7. The air conditioning system according to claim 1, wherein the heating portion is connected in the middle of the refrigerant pipe on an upstream side, a downstream side, or both of the upstream and the downstream sides of the compressor, based on a flow direction of the refrigerant.

8. The air conditioning system according to claim 2, wherein the magnetic material comprises at least one element selected from the group of Fe, Cr, Ni, Mn, Zn, Co, Cu and Si.

9. The air conditioning system according to claim 1, wherein the air conditioning system further comprises a control unit for controlling the heat pump cycle and the heating portion, and
wherein the control unit comprises controlling so as to heat the refrigerant in the heating portion by electromagnetic induction upon start of a heating operation mode of the heat pump cycle.

10. The air conditioning system according to claim 9, wherein the heat pump cycle further comprises a condenser for exchanging heat between air flowing through an air conditioning duct and the refrigerant, and
wherein the heating operation mode comprises compressing the refrigerant with the compressor and introducing the refrigerant discharged from the compressor into the condenser to heat the air.

11. The air conditioning system according to claim 10, wherein the heat pump cycle further comprises:
an evaporator for exchanging heat between the air flowing through the air conditioning duct and the refrigerant; and
an outdoor heat exchanger for exchanging heat between outside air and the refrigerant.

12. The air conditioning system according to claim 11, wherein the heating portion is connected in the middle of the refrigerant pipe at a position between the compressor and the condenser, or at a position between the compressor and the evaporator or the outdoor heat exchanger, or the heat portions are connected in the middle of the refrigerant pipe at both of the positions.

13. The air conditioning system according to claim 1, wherein the air conditioning system is for a vehicle.
